(19) United States
(12) Patent Application Publication
(10) Pub. No.: US 2015/0159615 A1
(43) Pub. Date: Jun. 11, 2015

(54) ENGINE OFF TEMPERATURE MANAGEMENT

(71) Applicant: Ford Global Technologies, LLC, Dearborn, MI (US)

(72) Inventors: John Robert Van Wiemeersch, Novi, MI (US); Patrick Kevin Holub, Novi, MI (US)

(73) Assignee: Ford Global Technologies, LLC, Dearborn, MI (US)

(21) Appl. No.: 14/102,756

(22) Filed: Dec. 11, 2013

(51) Int. Cl. F02N 11/08

(52) U.S. Cl. CPC F02N 11/0807

(57) ABSTRACT

A vehicle system includes an engine temperature sensor configured to measure a temperature of a vehicle engine and a remote engine controller system configured to compare the measured engine temperature to a predetermined threshold. The engine controller selectively activates the engine based on the measured engine temperature relative to the predetermined threshold to prioritize the heating of the engine block over heating of the vehicle cabin. In some implementations, the remote engine controller system selectively activates the engine when the measured temperature is below a minimum temperature and deactivates the engine when the measured temperature is equal to or greater than a target temperature.

### BACKGROUND

Passenger and commercial vehicles are designed to operate in a wide range of conditions. Some vehicles are consistently exposed to climates with high temperatures while others are consistently exposed to climates with low, often below freezing, temperatures. Some vehicles that were purchased for intended use in warm climates and then driven to cold climates may not be prepared to operate well in cold climates. Specifically, vehicles built without AC electric engine block heaters may be unable to start in cold climates due to low under-hood temperature resulting in low oil viscosity and increased block-to-cylinder friction caused by block shrinkage due to a cold engine block. Because other efficiencies, such as cabin comfort, are also gained when certain vehicle components can operate within a target temperature range, products like remote starters based on ambient temperature have also been used for the dual purpose of warming a vehicle's engine and passenger compartment in cold temperatures. However, using vehicle energy to warm both the engine block and passenger cabin is an inefficient solution if the goal is just to ensure the vehicle will start when needed in extreme cold weather. Additionally, re-starting the engine based on ambient temperature will result in more re-starts than necessary.

### BRIEF DESCRIPTION OF THE DRAWINGS

FIG. 1 illustrates an exemplary system for managing the temperature of a vehicle engine.

FIG. 2 is a flowchart of an exemplary process that may be used to manage the temperature of a vehicle engine.

### DETAILED DESCRIPTION

A system that remote starts the vehicle based engine temperature and configures the vehicle system to a low power state solely aimed at warming the engine block, thus emulating the function of an AC block heater, would be an improvement over existing remote start systems and methods. An exemplary vehicle system includes an engine temperature sensor configured to measure a temperature of a vehicle engine and a remote engine controller system configured to compare the measured temperature to a predetermined threshold. The remote engine controller system selectively activates the engine based on the measured temperature relative to the predetermined threshold. In some implementations, the remote engine controller system selectively activates the engine when the measured temperature is below a minimum temperature and deactivates the engine when the measured temperature is equal to or greater than a target temperature. Selectively activating the engine may protect the engine, and possibly other vehicle components, from the dangers of exposure to low temperatures while minimizing fuel consumption, reducing emissions, and minimizing engine run time. Moreover, activating the engine may have the added benefit of heating other vehicle components such as the battery, a diesel urea tank, etc. Further, there is a minimum time the engine must run in order to ensure the battery can recover sufficient charge to accomplish the next start request in persistent cold weather conditions.

The vehicle system shown in the FIGS. may take many different forms and include multiple and/or alternate components and facilities. While an exemplary system is shown, the exemplary components illustrated are not intended to be limiting. Indeed, additional or alternative components and/or implementations may be used.

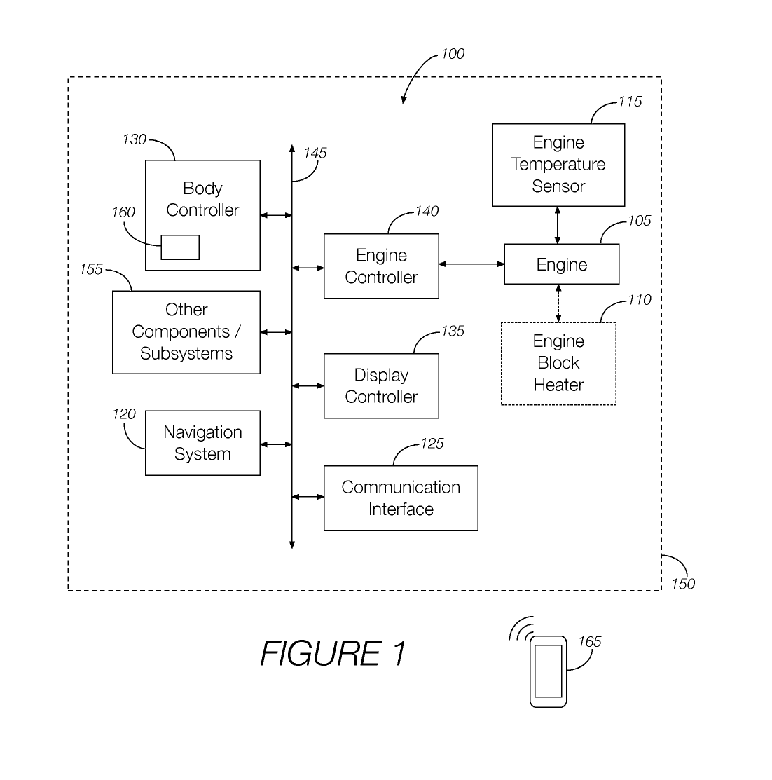

As illustrated in FIG. 1, the system 100 includes an engine 105, an optional engine block heater 110, an engine temperature sensor 115, a navigation system 120, a communication interface 125, a body controller 130, a display controller 135, and an engine controller 140. One or more of these components of the system 100 may communicate over a communication bus 145 or via direct communication lines between modules. An example of a communication bus 145 may include a controller area network (CAN) bus. The system 100 may be incorporated into a vehicle 150, such as any passenger or commercial car, truck, sport utility vehicle, crossover vehicle, van, minivan, motorcycle, or the like.

The engine 105 may include an internal combustion engine configured to convert a fuel, such as gasoline, into mechanical motion. The engine 105 may include one or more combustion chambers for oxidizing the fuel. The oxidized fuel may be compressed and ignited in the combustion chamber. The combustion in each chamber may generate a force that drives a piston to rotate a shaft. The engine 105 may include any number of combustion chambers. A cylinder block may define the combustion chambers as well as house the pistons and shaft that make up the engine 105. The cylinder block may be cast from, e.g., iron, an aluminum alloy, or any other material that can transfer heat to engine coolant that runs through the cylinder block.

The engine temperature sensor 115 may be configured to measure a temperature of the engine 105 directly (i.e., the cylinder block or engine 105 head) or of the coolant that transfers heat away from the cylinder block. In general, the engine coolant may include a water-based liquid with a freezing point lower than that of water. As coolant flows through channels in the cylinder block, heat is transferred from the cylinder block to the coolant. The coolant may be then passed to a heat exchanger to lower the temperature of the coolant before the coolant is returned to the cylinder block. The engine temperature sensor 115 may measure the temperature of the coolant while inside the cylinder block or immediately after leaving the cylinder block (i.e., before the coolant passes through the heat exchanger). The temperature of the coolant may act as a proxy for the temperature of the engine 105. The engine temperature sensor 115 may be configured to output an analog temperature signal that is directly connected to the input pin of at least one control module, such as the engine controller 140.

The engine block heater 110, if included in the vehicle 150, may be configured to warm the engine 105, and in particular, the cylinder block. Vehicles 150 equipped with an AC block heater 110 may often not have access to AC power and/or combined use the AC block heater 110 with the remote start engine block heating function described herein may allow improved heating of the engine block. The AC engine block heater 110 may include an electric heating element that generates heat when a voltage is applied. The engine block heater 110, therefore, may be configured to plug into a power source, such as an alternating current source. The engine block heater 110 may be monitored by the engine controller 140 or the body controller 130, either of which may be configured to communicate the engine block heater status over the communication bus 145. For instance, the engine block heater 110 may include a monitor module configured to generate and output signals indicating when the engine block heater 110 has been activated and when the engine block heater 110 has been deactivated. Additionally, the monitor module of the engine block heater 110 may be configured to receive the signal representing the temperature measured by the engine temperature sensor 115.

The navigation system 120 may be configured to determine a position of the vehicle 150. For example, the navigation system 120 may include a Global Positioning System (GPS) receiver configured to triangulate the position of the vehicle 150 relative to satellites or terrestrial based transmitter towers. The navigation system 120, therefore, may be configured for wireless communication. The navigation system 120 may be further configured to display a map via, e.g., a user interface device, as well as present driving directions to a destination. The navigation system 120 may be further configured to make determinations about the location of the vehicle 150 even if the specific location cannot be determined. For instance, if the navigation system 120 is unable to communicate with GPS satellites, the navigation system 120 may determine that the vehicle 150 is located in a structure such as a garage or parking structure. The navigation system 120 may be configured to output signals representing the present location of the vehicle 150 including whether the vehicle 150 is located in a structure. Alternatively, when communication is lost with GPS satellites or terrestrial towers, the navigation system 120 may maintain record of the vehicle's equivalent GPS location using a process of dead reckoning to extrapolate position from the last know GPS received coordinates based vehicle yaw, pitch, and roll, obtained from the vehicle crash restraints or vehicle dynamics systems.

The communication interface 125 may be configured to facilitate wired and/or wireless communication between the components of the vehicle 150 and other devices. For instance, the communication interface 125 may be configured to receive messages from, and transmit messages to, a cellular provider's tower and the vehicle's Telematics Service Delivery Network (SDN) that, in turn, establishes communication with the user's mobile device 165 such as a cell phone, a tablet computer, a laptop computer, a fob, or any other electronic device configured for wireless communication via a secondary or the same cellular provider. Cellular communication to the vehicles telematics transceiver through the SDN may also be initiated from an internet connected device such as a PC, Laptop, Notebook, or WiFi connected phone. The communication interface 125 may also be configured to communicate directly from the vehicle to the user's remote device using any number of communication protocols such as Bluetooth®, Bluetooth® Low Energy, or WiFi.

The body controller 130 may be configured to monitor and control various electronic devices and/or subsystems 155 in the vehicle 150. For example, the body controller 130 may be configured to monitor and/or control the operation of power windows, power mirrors, battery current, air conditioning, door and trunk locks, the hood switch, an intrusion system, an occupant detection system, adjustable seat controls, interior and/or exterior lighting controls, the defrost system, mirror heaters, seat heaters, steering wheel heaters, or the like. The body controller 130 may be configured to receive signals from, and output signals to, any one or more of these and possibly other devices and/or subsystems 155.

The display controller 135 may be configured to receive inputs from, and output signals to, a user interface device having a display located in the passenger compartment of the vehicle 150. The user interface device may present information to a user, such as a driver, during operation of the vehicle 150. Moreover, the user interface device may be configured to receive user inputs. In some possible approaches, the user interface device may include a touch-sensitive display screen. The display controller 135 may be configured to process user inputs received through the user interface device as well as output signals representing the information to be displayed to the user. Examples of user inputs processed by the display controller 135 may include climate control settings, audio control settings, hazard light settings, or the like. Examples of outputs may include control signals for the HVAC system (e.g., vents, fans, etc.) and control signals for the audio system.

The engine controller 140 may be configured to control the operation of the engine 105 and possibly other powertrain components, including the transmission. For instance, the engine controller 140 may control the combustion timing discussed above. The engine controller 140 may be configured to receive inputs from various components and/or subsystems 155 of the vehicle 150. Examples of inputs may include the temperature measured by the engine temperature sensor 115, a fuel level, a diagnostic fault, a transmission state, or the like.

The remote engine controller system 160, which may be wholly or partially incorporated into the body controller 130 or possibly the engine controller 140, may be configured to activate the engine 105 under various conditions, such as to heat the engine in low temperature conditions. For instance, the engine controller 140 may be configured to receive the measured temperature from the engine temperature sensor 115. As discussed above, the temperature of the engine coolant may act as a proxy for the temperature of the engine 105. The remote engine controller system 160 may compare the measured temperature to a predetermined threshold and selectively activate the engine 105 based on the measured temperature relative to the predetermined threshold. One way to selectively activate the engine 105 is for the remote engine controller system 160 to generate a command signal that causes the engine 105 to start. The command signal may be transmitted from the remote engine controller system 160 to, e.g., the engine controller 140. While the remote engine controller system 160 could be integrated into the engine controller module 140, it may instead be part of the body controller module 130 since the body controller module 130 may monitor key fob commands and since the engine controller 140 is typically off when the engine 105 is off.

The predetermined threshold may define a minimum temperature. In some instances, the predetermined threshold may further define a target temperature. When instructed by the body controller 130, the engine controller 140 may activate the engine 105 when the measured temperature drops below the minimum temperature, and if a target temperature is defined, the body controller 130 may instruct the engine controller 140 to deactivate the engine 105 when the engine temperature is equal to or greater than the target temperature.

The remote engine controller system 160 may consider additional factors, besides temperature, before activating the engine 105. Other factors may include, e.g., conditions of one or more vehicle components or subsystems 155. The conditions considered by the remote engine controller system 160 may relate to instances where the engine 105 should not be activated. For instance, the remote engine controller system 160 may recognize that activating the engine 105 at certain times, such as when a hood of the vehicle 150 is open or while the vehicle 150 is located in an enclosed structure such as a garage, may cause injury to a person located near the vehicle 150. Moreover, activating the engine 105 for heating purposes when, e.g., the fuel level is too low or when a diagnostic fault has been detected, could strand the vehicle 150. Other conditions may suggest that the driver is near the vehicle 150 and/or about to start the engine 105 or that occupants have been left in the cabin for a vehicle that is not configured to optimize cabin comfort, but rather only engine temperature. Examples may include an occupant detection system detecting the presence of an occupant, particularly in the driver's seat, an intrusion detection system detecting the presence of an intruder, the lock switches changing from a locked position to an unlocked position, the interior and/or exterior lights being turned on, a seat being adjusted, a change in the climate controls and/or audio controls, someone turning on the hazard lights, the driver or another occupant approaching the vehicle 150 as determined by the proximity of a mobile device 165 to the vehicle 150, etc. Moreover, the engine controller 140 may determine that the engine 105 does not need to be activated if the engine block heater 110 is turned on and already warming the engine 105, although having both the engine block heater 110 and engine 105 activated may further speed the heating of the engine 105. Thus, the engine 105 may be activated even if the engine block heater 110 is turned on if, for example, the measured temperature is below a certain threshold such as −40 degrees Fahrenheit.

In some instances, the condition may be detected by the body controller 130. Other components, such as the engine controller 140, the display controller 135, the communication interface 125, and/or the navigation system 120 may be configured to detect the same conditions discussed above or other conditions and notify the engine controller 140. The engine controller 140 may be configured to activate the engine 105 for purposes of heating the engine 105 based on the measured temperature and the vehicle condition regardless of how the condition is detected.

If the engine 105 is not activated due to a detected condition, a notification may be generated by one or more of the engine controller 140, the body controller 130, the display controller 135, and the communication interface 125. Examples of notifications may include causing a horn to beep or sending an electronic communication to the driver's mobile device 165 or an email to their account.

The engine controller 140, the body controller 130, and/or the display controller 135 may be configured to activate and/or deactivate various subsystems 155 or components while the engine 105 is activated for heating purposes to reduce emissions, reduce fuel consumption, and minimize engine run time. For example, the windshield defroster may remain enabled while heated seats, a heated steering wheel, heated mirrors, rear defroster, the audio system, the navigation system 120, windshield wipers, turn signals, interior and/or exterior lights, etc., may be deactivated until the vehicle 150 is started or receives a key fob unlock command or a door opens. Moreover, the heating of the passenger compartment may be minimized or deactivated until the vehicle 150 is started. In some possible implementations, these components and/or subsystems 155 may be deactivated prior to the engine controller 140 activating the engine 105.

Once the engine 105 has been activated, a notification may be generated indicating that the engine 105 has been started for purposes of warming the engine 105. The notification may be audible (e.g., briefly beeping the horn) or may be a wireless communication sent from the vehicle 150 via the communication interface 125 to a driver's mobile device 165 or email account. Another notification may be generated when the engine 105 is deactivated when, for instance, the measured temperature is equal to or greater than the target temperature.

The user interface may include providing the GUI on the vehicle center stack screen rather than a remote start fob or phone application so that the user can activate the system in the absence of a phone, or adequate cellular signal strength. Additionally, use of the center screen as the primary GUI may allow the feature to be free standard equipment on a vehicle even in the absence of the vehicle being equipped with a remote starter.

In general, computing systems and/or devices, such as the navigation system 120, the communication interface 125, the body controller 130, the display controller 135, and the engine controller 140 may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on-board vehicle 150 computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

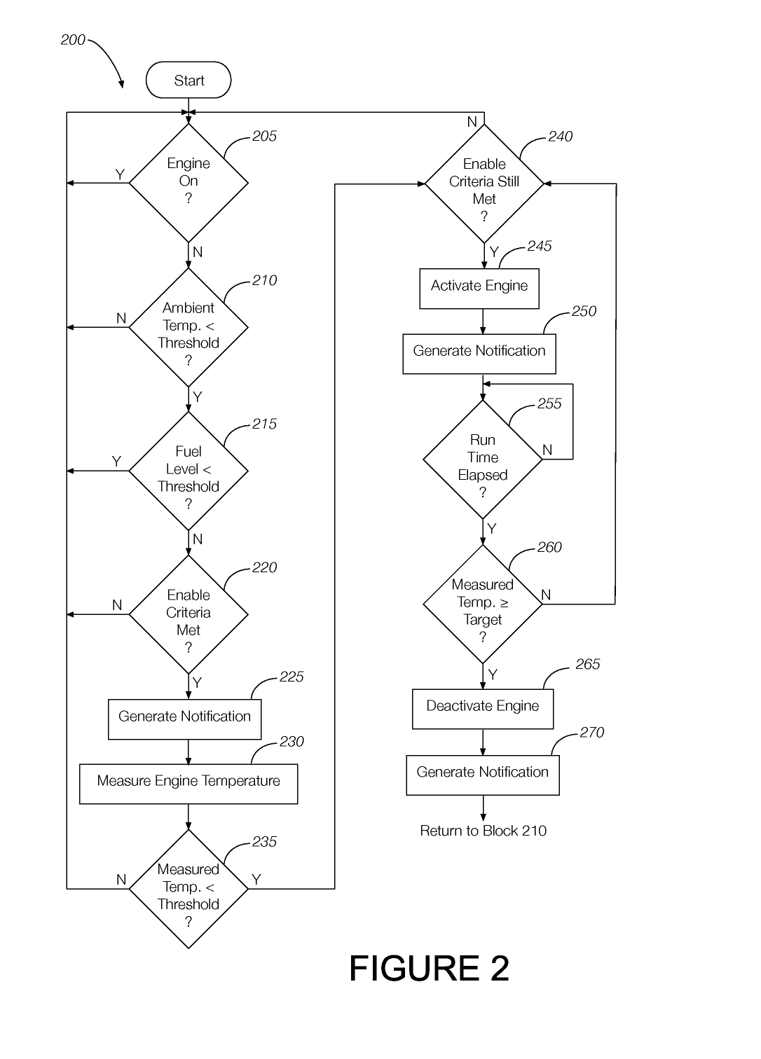

FIG. 2 is a flowchart of an exemplary process 200 that may be implemented by one or more components of the system 100 of FIG. 1.

The start of the logic flow in FIG. 2 may be initiated by a user interface that allows the user to select a maximum total run time for the feature. For example, the remote engine controller system may periodically start the engine to keep the block warm and may continue start-stop cycles for one of, e.g., four selected total run time periods of 30 minutes, 1 hour, 2 hour, or 3 hours, capping the total run time to avoid using all available fuel in the vehicle tank. Further, at the start of the routine, it may be desirable to notify the user of important criteria that must be met in order for the remote engine controller system to provide its intended function (e.g., no fob left inside, all doors closed, all doors locked, vehicle in park, etc.).

At decision block 205, the remote engine controller system 160 may determine whether the engine 105 is currently running. The engine 105 may be running if the vehicle 150 is turned on (i.e., a key in the ignition switch is turned to an “on” position). The process 200 may not continue until the engine 105 is turned off. Thus, block 205 may be repeated until the engine 105 is turned off. Once off, the process 200 may continue at block 210.

At decision block 210, the remote engine controller system 160 may determine whether the ambient air temperature in the vicinity of the vehicle 150 is below a predetermined threshold. An example threshold may be 25 degrees Fahrenheit. If the ambient air temperature is below the threshold, the process 200 may continue at decision block 210. If the ambient air temperature is above the threshold, the process 200 may return to decision block 205.

At decision block 215, the remote engine controller system 160 may determine whether the fuel level in the vehicle is below a predetermined threshold. The predetermined threshold may be relative to a full fuel tank. Therefore, the predetermined threshold may be when the fuel tank is one-quarter full. If the fuel level is below the predetermined threshold, the process 200 may continue at decision block 205. If the fuel level is above the predetermined threshold, the process 200 may continue at decision block 220.

At decision block 220, the remote engine controller system 160 may determine whether one or more enable criterion has been met. The criterion may relate to instances where the engine 105 should not be activated for heating purposes such as if activating the engine 105 at certain times could cause injury to a such as when persons are located near the vehicle 150, a key fob is left inside that could be used to driver away, a door is open, the vehicle is unlocked, the engine heater run time has not expired, when the fuel level is too low, when a diagnostic fault has been detected, when the driver is near the vehicle 150 and/or about to start the engine 105, when the engine block heater 110 is turned on and already warming the engine 105, etc. The condition may be detected by the remote engine controller system 160. The remote engine controller system 160 may be incorporated into the body control module 130 but other components such as the engine controller 140, the display controller 135, the communication interface 125, and/or the navigation system 120 may be configured to detect the condition and notify the remote engine controller system 160. The enable criterion may include any one or more of whether a run time has expired, whether the vehicle doors are closed, whether a fob is detected inside the vehicle, whether any inputs have been received on the cabin controls, or the like. If the criteria have been met, the process 200 may continue at block 225. If the criteria have not been met, the process 200 may return to decision block 205.

At block 225, the remote engine controller system 160 may provide a notification to the user that the engine off temperature will be controlled. The notification may include beeping the horn, sending a message to the driver's mobile device 165, or the like.

At block 230, the engine controller 140 may measure the temperature of the engine 105 at pre-defined intervals based on expected known cooling rates for the engine block based on ambient temperature, block size, and block temperature at the key-off event. The sample intervals may be as infrequent as possible, to reduce battery current consumption. The engine temperature may be determined from the temperature of the engine coolant. The engine temperature sensor 115 may measure the coolant temperature. The engine controller 140 may determine the engine temperature based on one or more signals received from the engine temperature sensor 115.

At decision block 235, the remote engine controller system 160 may compare the measured temperature to a predetermined threshold. The predetermined threshold may define a minimum temperature and a target temperature. If the measured temperature is below the minimum temperature, the process 200 may continue at decision block 240. If the measured temperature is not below the minimum temperature, the process 200 may return to decision block 205.

At decision block 240, the remote engine controller system 160 may determine whether the enable criteria are still satisfied. If one or more criteria are not satisfied, the process 200 may return to block 205. Otherwise, the process 200 may continue at block 245. In some instances, a notification may be provided indicating that the engine 105 will not be activated because the criteria have not been satisfied. Examples of notifications may include beeping the horn or sending a message to a driver's mobile device 165 or email account.

At block 245, the remote engine controller system 160 may activate the engine 105 to begin to warm the engine 105 to the target temperature. To preserve fuel, reduce emissions, and minimize engine run time, the remote engine controller system 160 may be configured to activate and/or deactivate various subsystems 155 or components. Heated seats, a heated steering wheel, heated mirrors, rear defroster, the audio system, the navigation system 120, windshield wipers, turn signals, interior and/or exterior lights, etc., may be deactivated while the engine 105 is warming up. Likewise, the heating of the passenger compartment may be minimized or deactivated. In some possible implementations, these and possibly other components and/or subsystems 155 may be deactivated prior to activating the engine 105.

At block 250, a notification may be generated that indicates that the engine 105 has been activated. The notification may be generated by the remote engine controller system 160. The notification may include beeping the horn, sending a message to the driver's mobile device 165, or the like.

At decision block 255, the remote engine controller system 160 may determine whether the run time has elapsed. The run time may be based on a predetermined value or selected by a user. Examples of run times may include, e.g., 30 minutes, 1 hour, 2 hours, or 3 hours. If the run time has elapsed, the process may continue at block 260. Otherwise, block 255 may be repeated until the run time has elapsed.

At decision block 260, the remote engine controller system 160 may continue to monitor the measured temperature of the engine 105 while the engine 105 is active. The process 200 may return to block 240 if the measured temperature is determined to be below the target temperature. When the measured temperature is determined to be equal to or greater than the target temperature, the process 200 may continue at block 265.

At block 265, the engine 105 may be deactivated. Deactivating the engine 105 when the measured temperature is equal to or greater than the target temperature may minimize fuel consumption, reduce emissions, and minimize engine run time. The process 200 may return to block 210 after the engine 105 is deactivated.

At block 270, a notification may be generated that indicates that the engine 105 has been activated. Like the notifications generated at blocks 225 and 250, the notification may be generated by the remote engine controller system 160. The notification may include beeping the horn, sending a message to the driver's mobile device 165, or the like. In some possible approaches, the process 200 may return to block 210 after block 270. Alternatively, the process 200 may continue at block 220 or may end after block 270.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle comprising:
an engine temperature sensor configured to measure a temperature of a vehicle engine;
a remote engine controller system configured to compare the measured engine temperature to a predetermined threshold and selectively activate the engine based on the measured engine temperature relative to the predetermined threshold.

2. The vehicle of claim 1, wherein the predetermined threshold defines a minimum temperature, and wherein the remote engine controller system is configured to activate the engine when the measured engine temperature is below the minimum temperature.

3. The vehicle of claim 1, wherein the predetermined threshold defines a target temperature, and wherein the remote engine controller system is configured to deactivate the engine when the measured engine temperature is equal to or greater than the target temperature.

4. The vehicle of claim 1, wherein the remote engine controller system is configured to selectively activate the engine based on the measured engine temperature relative to the predetermined threshold and a vehicle condition.

5. The vehicle of claim 4, wherein the remote engine controller system is configured to detect the vehicle condition.

6. The vehicle of claim 4, further comprising a body controller configured to detect the vehicle condition.

7. The vehicle system of claim 4, further comprising a display controller configured to detect the vehicle condition.

8. The vehicle of claim 1, further comprising a body controller configured to deactivate at least one vehicle subsystem prior to the remote engine controller system selectively activating the engine.

9. The vehicle of claim 1, further comprising a display controller configured to deactivate at least one vehicle subsystem prior to the remote engine controller system selectively activating the engine.

10. The vehicle of claim 1, further comprising a communication interface configured to transmit a message indicating that the engine has been activated.

11. A method comprising:
measuring an engine temperature;
comparing the measured engine temperature to a predetermined threshold; and
selectively activating the engine based on the measured temperature relative to the predetermined threshold.

12. The method of claim 11, wherein the predetermined threshold defines a minimum temperature, and wherein the engine is activated if the measured temperature is below the minimum temperature.

13. The method of claim 11, wherein the predetermined threshold defines a target temperature, and wherein the engine is deactivated when the measured temperature is equal to or greater than the target temperature.

14. The method of claim 11, wherein the engine is selectively activated based on the measured temperature relative to the predetermined threshold and a vehicle condition.

15. The method of claim 14, further comprising detecting the vehicle condition.

16. The method of claim 14, further comprising deactivating at least one vehicle subsystem prior to selectively activating the engine.

17. The method of claim 11, further comprising deactivating at least one vehicle subsystem prior to selectively activating the engine.

18. The method of claim 11, further comprising transmitting a message indicating that the engine has been activated.

19. A vehicle comprising:
an engine temperature sensor configured to measure a temperature of a vehicle engine;
a remote engine controller system configured to compare the measured engine temperature to a predetermined threshold defining a minimum temperature and a target temperature,
wherein the remote engine controller system is configured to selectively activate the engine when the measured engine temperature is below the minimum temperature and deactivate the engine when the measured engine temperature is equal to or greater than the target temperature.

20. The vehicle of claim 19, further comprising a communication interface configured to transmit a message indicating that the engine has been activated.
